(19) United States
(12) Patent Application Publication
(10) Pub. No.: US 2023/0076951 A1
(43) Pub. Date: Mar. 9, 2023

(54) ELECTRICALLY DRIVEN REDUNDANT FUEL AND OIL PUMPING SYSTEM FOR GAS TURBINE ENGINES

(71) Applicant: Rolls-Royce North American Technologies Inc., Indianapolis, IN (US)

(72) Inventor: Alan W. Smith, Greenwood, IN (US)

(21) Appl. No.: 17/469,843

(22) Filed: Sep. 8, 2021

(51) Int. Cl. F02C 7/236; F02C 7/06; F02C 7/32; F02C 9/30

(52) U.S. Cl. CPC F02C 7/236; F02C 7/06; F02C 7/32; F02C 9/30; F05D 2220/323; F05D 2260/4023; F05D 2260/84; F05D 2260/98; F05D 2270/094

(57) ABSTRACT

A redundant oil and fuel pumping system for use with a gas turbine engine. The pumping system includes a plurality of power supplies, a fuel system and an oil system. The fuel system pump being driven by electric motors controlled via variable frequency drives powered by the plurality of power supplies. The oil system pump being driven by electric motors controlled via variable frequency drives powered by the plurality of power supplies.

### FIELD OF THE DISCLOSURE

The present disclosure relates generally to gas turbine engines, and more specifically to electrically driven fuel and oil pumping system adapted for use in gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Gas turbine engines may be powered by a fuel source that is combusted during operation of the gas turbine engine. The fuel source may be stored in a tank and pumped from the tank to the combustor of the gas turbine engine. Gas turbine engines may use lubricant in areas with rotating components to cool the components and reduce friction produced during the operation of the gas turbine engine. The lubricant may collect in one or more sumps and can be recirculated back to the areas of the gas turbine engine using oil pumps. Fuel and oil pumping systems that are electrically driven remains an area of interest in the field of gas turbine engines.

### SUMMARY

The present disclosure may comprise one or more of the following features and combinations thereof.

A pumping system for use with a gas turbine engine includes a fuel system configured for redundant operation and an oil system configured for redundant operation. The fuel system includes a first fuel pump motor, a second fuel pump motor, a fuel pump, and a fuel pump shaft. The first fuel pump motor and the second fuel pump motor are mechanically connected in series with the fuel pump via the fuel pump shaft, such that the fuel pump is configured to be driven by both or a single one of the first fuel pump motor and the second fuel pump motor. The oil system includes a first oil pump motor, a second oil pump motor, an oil pump, and an oil pump shaft. The first oil pump motor and the second oil pump motor are mechanically connected in series with the oil pump via the oil pump shaft, such that the oil pump is configured to be driven by both or a single one of the first oil pump motor and the second oil pump motor.

A method for use with a gas turbine engine includes supplying electric power to a first pump motor from a first power supply, supplying electric power to a second pump motor from a second power supply independent from the first power supply, driving a pump with the first pump motor and the second pump motor via a pump shaft, and driving the pump with one of the first pump motor and the second pump motor to optimize the power split to each pump based on the health of the two pump drive systems.

These and other features of the present disclosure will become more apparent from the following description of the illustrative embodiments.

### BRIEF DESCRIPTION OF THE DRAWINGS

FIG. 1 is a block diagram illustrating a pumping system in accordance with the present disclosure and adapted for use in a gas turbine engine, the pumping system including a motor generator, a fuel system configured for redundant powered operation, and an oil system configured for redundant powered operation;

FIG. 2A is a block diagram illustrating the fuel fuel system included in the pumping system of FIG. 1, the fuel system including a first fuel pump motor, a second fuel pump motor, a fuel pump, and a fuel pump shaft, wherein the first fuel pump motor and the second fuel pump motor are mechanically connected in series with the fuel pump via the fuel pump shaft, and each of the first fuel pump motor and the second fuel pump motor being electrically connected to a different one of a plurality of power supplies such that the fuel pump is configured to be driven by both or a single one of the first fuel pump motor and the second fuel pump motor;

FIG. 2B is a block diagram illustrating the oil system included in the pumping system of FIG. 1, the oil system including a first oil pump motor, a second oil pump motor, an oil pump, and an oil pump shaft, wherein the first oil pump motor and the second oil pump motor are mechanically connected in series with the oil pump via the oil pump shaft, and each of the first oil pump motor and the second oil pump motor being electrically connected to a different one of a plurality of power supplies such that the oil pump is configured to be driven by both or a single one of the first oil pump motor and the second oil pump motor;

FIG. 2C is a block diagram illustrating the fuel fuel system included in the pumping system of FIG. 1, the fuel system including a first fuel pump motor, a second fuel pump motor, a fuel pump, overrunning clutches, and a fuel pump shaft, the first fuel pump motor and the second fuel pump motor being mechanically connected in series with the overrunning clutches and with the fuel pump via the fuel pump shaft, and each of the first fuel pump motor and the second fuel pump motor being electrically connected to a different one of a plurality of power supplies such that the fuel pump is configured to be driven by both or a single one of the first fuel pump motor and the second fuel pump motor; and

FIG. 3 is a process including supplying electric power to a first pump motor from a first power supply, supplying electric power to a second pump motor from a second power supply electrically independent from the first power supply, driving a pump with the first pump motor and the second pump motor via a pump shaft, and driving the pump with only one of the first pump motor and the second pump motor in response to the other of the first pump motor and the second pump motor becoming inoperable to continuously drive the pump without interruption.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

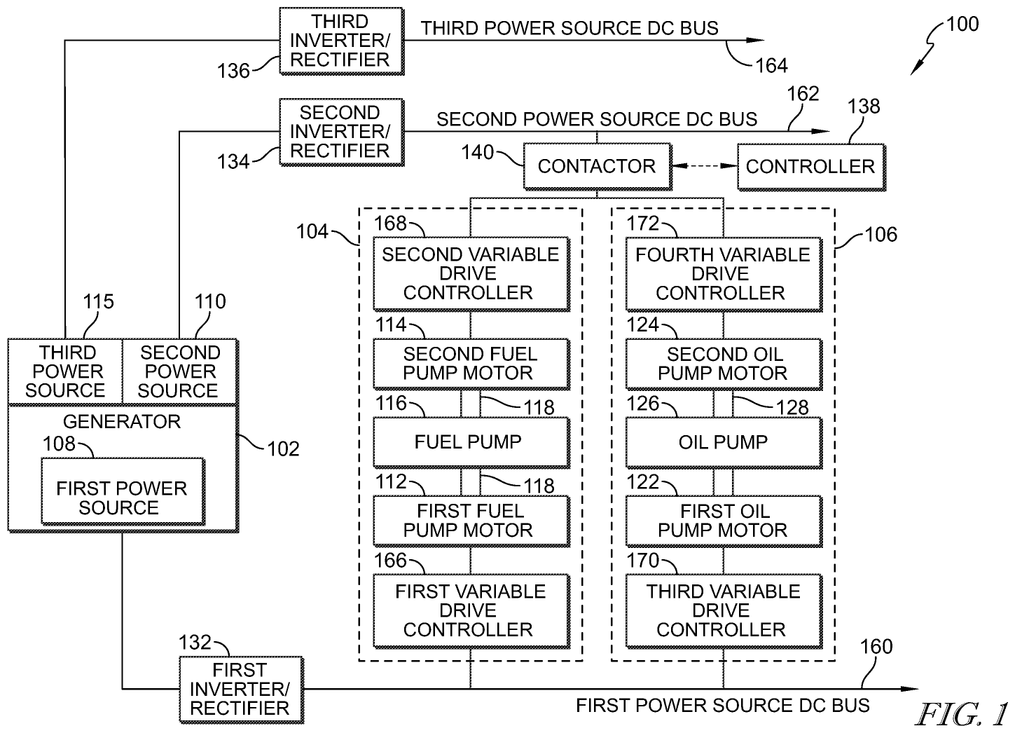

A pumping system 100 for use with a gas turbine engine is shown in FIG. 1. The pumping system 100 is configured for redundant powered operation and includes a motor generator 102, a fuel system 104, and an oil system 106. The motor generator 102 includes a plurality of power supplies 108, 110, 115.

Alternating current (AC) power output by each of the plurality of power supplies 108, 110, 115 of the generator 102 is converted to direct current (DC) power, e.g., rectified, by a corresponding one of a first inverter-rectifier 132, a second inverter-rectifier 134, and a third inverter-rectifier 136. Output of the first inverter-rectifier 132 may be electrically connected to a first power source DC bus 160. Output of the second interver-rectifier 134 may be electrically connected to a second power source DC bus 162. Output of the third inverter-rectifier 136 may be electrically connected to a third power source DC bus 164. Additionally, the DC buses 160, 162 and 164 can also be powered by an alternate source of DC power for example a battery on the aircraft.

Additionally or alternatively, the first inverter-rectifier 132, the second inverter-rectifier 134, and the third inverter-rectifier 136 may invert input DC power transferred, e.g., from a battery or another energy storage device, via a corresponding one of the first power source DC bus 160, the second power source DC bus 162, and the third power source DC bus 164 to AC power for use by the generator 102 via a respective one of the plurality of power supplies 108, 110, 115 when the generator 102 is operating as a motor and providing drive torque to the engine for example during starting of the gas turbine engine.

The fuel system 104 includes a first fuel pump motor 112, a second fuel pump motor 114, a fuel pump 116, and a fuel pump shaft 118. The first fuel pump motor 112 and the second fuel pump motor 114 are mechanically connected in series with the fuel pump 116 via the fuel pump shaft 118. Each of the first fuel pump motor 112 and the second fuel pump motor 114 are electrically connected to and powered by one of the plurality of power supplies 108, 110 of the generator 102.

In one example, the first fuel pump motor 112 may be driven by a first variable drive controller 166 that is powered by the first power source DC bus 160 and the second fuel pump motor 114 may be driven by a second variable drive controller 168 that is powered by the second power source DC bus 162. Each of the first fuel pump motor 112 and the second fuel pump motor 114 may be a surface or an internal permanent magnet motor configured to operate according to and synchronously with the input drive frequency.

The fuel pump 116 is configured to be driven by both or a single one of the first fuel pump motor 112 and the second fuel pump motor 114. The fuel pump 116 is a positive displacement pump configured such that fuel flow within the fuel system is proportional to the speed of the fuel pump 116. Examples of the fuel pump 116 include, but are not limited to, a gear pump, a generated rotor pump (or gerotor pump), and a vane pump.

The oil system 106 is configured for redundant powered operation and includes a first oil pump motor 122, a second oil pump motor 124, an oil pump 126, and an oil pump shaft 128. The first oil pump motor 122 and the second oil pump motor 124 are mechanically connected in series with the oil pump 126 via the oil pump shaft 128. Each of the first oil pump motor 122 and the second oil pump motor 124 is electrically connected to and powered by one of the plurality of power supplies 108, 110. The first oil pump motor 122 is driven by a third variable drive controller 170 that is powered by the first power source DC bus 160. The second oil pump motor 124 is driven by a fourth variable drive controller 172 that is powered by the second power source DC bus 162.

The oil pump 126 is configured to be driven by both or a single one of the first oil pump motor 122 and the second oil pump motor 126. The oil pump 126 is a positive displacement pump configured such that fuel flow within the fuel system is proportional to the speed of the oil pump 126. Examples of the oil pump 126 include, but are not limited to, a gear pump, a generated rotor pump, and a vane pump.

The first power supply 108 of the motor generator 102 may comprise a first power source configured to supply power to the first fuel pump motor 112 and the first oil pump motor 122. The first power supply 108 may supply power to one or more other components of an aircraft, such as, but not limited to, an engine (not shown). The second power supply 110 of the motor generator 102 may comprise a second power source and may be electrically connected to supply power to the second fuel pump motor 114 and the second oil pump motor 124. The third power supply 115 may provide power to multiple electrical buses. For example, the third power supply 115 may be electrically connected via connection 150 to power one or more aircraft systems, subsystems, and/or components. Other implementations, such as implementations including different power sources and/or a different number of power sources are also contemplated.

In one example, the first inverter-rectifier 132 converts AC power generated by the generator 102 to DC power for use by the first variable drive controller 166, the third variable drive controller 170, the first fuel pump motor 112, the first oil pump motor 122, and other components powered by the first power supply 108. As another example, the second inverter-rectifier 134 converts AC power generated by the generator 102 to DC power for use by the second variable drive controller 168, the fourth variable drive controller 172, the second fuel pump motor 114, the second oil pump motor 124, and other components powered by the second power supply 110.

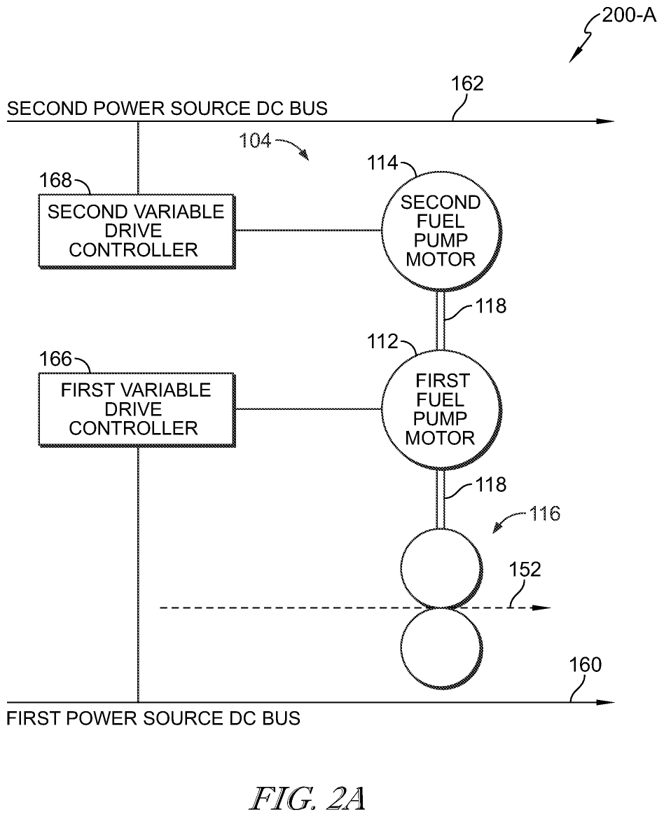

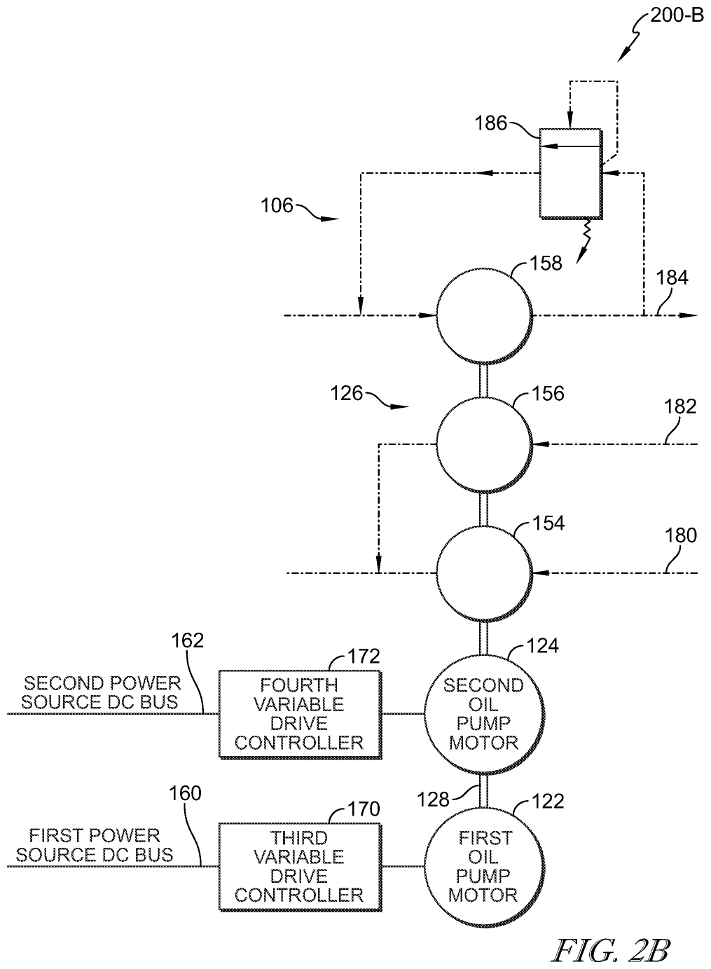

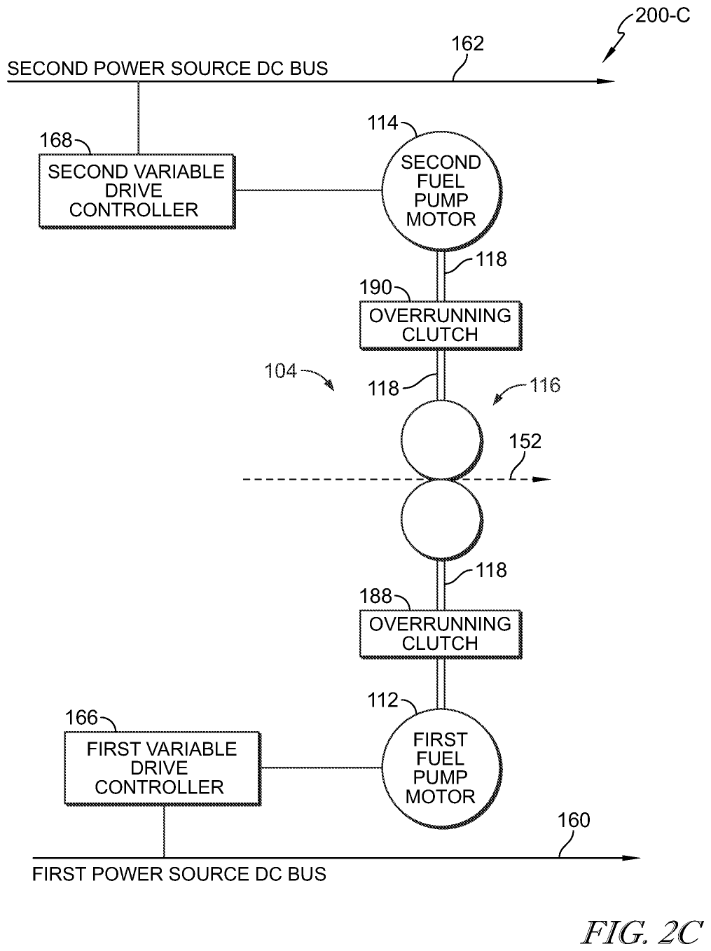

In one embodiment of the system a controller 138 monitors and controls operation of the fuel system 104 and the oil system 106, such as by monitoring and controlling operation of one or more other controllers, control modules, or other components that perform logic and/or processing operations to control operation of subcomponents of the fuel system 104 and the oil system 106. As described in reference to at least FIGS. 2A-2B, the controller 138 is communicatively connected to the first variable drive controller 166 and the second variable drive controller 168 that are, in turn, connected to the first fuel pump motor 112, the second fuel pump motor 114, and the fuel pump 116 to monitor and control operation of the first fuel pump motor 112, the second fuel pump motor 114, and the fuel pump 116. The controller 138 is communicatively connected to the third variable drive controller 170 and the fourth variable drive controller 172 that are, in turn, connected to the first oil pump motor 122, the second oil pump motor 124, and the oil pump 126 to monitor and control operation of the first oil pump motor 122, the second oil pump motor 124, and the oil pump 126. The controller 138 needs to be partitioned to provide two separate and isolated controls for each of the two fuel pumps and each of the two oil pumps using different power supplies to provide redundancy to the fuel and oil pump functions.

A high-power switch or contact breaker, such as a contactor 140, is electrically connected between the second power supply 110 and both the second fuel pump motor 114 and the second oil pump motor 124. The controller 138 operates to open and close the contactor 140 based on one or more operating conditions of the system 100. In an example, the controller 138 sends a signal or issues a command to open the contactor 140 to electrically disconnect the second fuel pump motor 114 and the second oil pump motor 124 from the second power supply 110. In another example, the controller 138 sends a signal or issues a command to close the contactor 140 to electrically connect the second fuel pump motor 114 and the second oil pump motor 124 to the second power supply 110. In some instances, one or more of the first variable drive controller 166, the second variable drive controller 168, the third variable drive controller 170, and the fourth variable drive controller 172 may be embodied as being a part of controller 138, where each variable drive controller is independent and isolated from the other variable drive controllers.

FIGS. 2A and 2B illustrate a pumping system 200-A and a pumping system 200-B, respectively, for use with a gas turbine engine. The pumping system 200-A includes the fuel system 104 configured for redundant powered operation and the pumping system 200-B includes the oil system 106 configured for redundant powered operation.

The fuel system 104 includes the first fuel pump motor 112, the second fuel pump motor 114, the fuel pump 116, and the fuel pump shaft 118. The first fuel pump motor 112 and the second fuel pump motor 114 are mechanically connected in series with the fuel pump 116 via the fuel pump shaft 118. The oil system 106 includes the first oil pump motor 122, the second oil pump motor 124, the oil pump 126, and the oil pump shaft 128. The first oil pump motor 122 and the second oil pump motor 124 are mechanically connected in series with the oil pump 126 via the oil pump shaft 128.

As shown in FIG. 2A, each of the first fuel pump motor 112 and the second fuel pump motor 114 is connected such that the fuel pump 116 is configured to be driven by both or a single one of the first fuel pump motor 112 and the second fuel pump motor 114. The variable drive controllers 166 and 168 control the fuel flow by controlling the speed of the fuel pump 116, one or both of the first variable drive controller 166 and the second variable drive controller 168 supply electric power to a corresponding one of the first fuel pump motor 112 and the second fuel pump motor 114 to drive the fuel pump 116 to achieve the required pump speed. The fuel pump 116 is fluidly connected to a fuel supply line 152.

The first variable drive controller 166 and the second variable drive controller 168 control the first fuel pump motor 112 and the second fuel pump motor 114 to cause the fuel pump 116 to achieve the required operating speed corresponding to the fuel flow to the engine. The first variable drive controller 166 and the second variable drive controller 168 may be commanded or programmed to control electric power supplied to the first fuel pump motor 112 and to the second fuel pump motor 114 to divide and optimize the power to be delivered by each of the first fuel pump motor 112 and the second fuel pump motor 114.

In one example, the first variable drive controller 166 and the second variable drive controller 168 are programmed to vary the electric power supplied to the first fuel pump motor 112 and the second fuel pump motor 114 to divide the power demand of the fuel pump 116 between the first fuel pump motor 112 and the second fuel pump motor 114. The power distribution may split 100 percent power in any amount between the two pump motors 112, 114. For example, the power may be distributed 50/50, 40/60, 30/70, 25/75, 20/80, 10/90, 5/95, 0/100 between the two pump motors 112, 114. The first variable drive controller 166 and the second variable drive controller 168 may control the power split by controlling the proportion of torque output by each of the first fuel pump motor 112 and the second fuel pump motor 114. For example, to achieve a predefined desired speed of the fuel pump 116, the first variable drive controller 166 and the second variable drive controller 168 may operate the first fuel pump motor 112 and the second fuel pump motor 114 to produce output torque values that are equal for a 50/50 power split or may operate the first fuel pump motor 112 to output twice the amount of torque output by the second fuel pump motor 114 for a 66/33 power split.

In some instances, one or both of the first fuel pump motor 112 and the second fuel pump motor 114 is configured to operate in a speed control mode. In other instances, one or both of the first fuel pump motor 112 and the second fuel pump motor 114 is configured to operate in a torque control mode. Put another way, the first variable drive controller 166 and the second variable drive controller 168 are programmed to operate both the first fuel pump motor 112 and the second fuel pump motor 114 in one of the speed control mode and the torque control mode.

In the speed control mode, each of the first variable drive controller 166 and the second variable drive controller 168 controls frequency input to the first fuel pump motor 112 and the second fuel pump motor 114 to achieve the required speed of the first fuel pump motor 112 and the second fuel pump motor 114. In the torque control mode, each of the first variable drive controller 166 and the second variable drive controller 168 controls amount of current supplied to the first fuel pump motor 112 and the second fuel pump motor 114 to achieve the required torque of the first fuel pump motor 112 and the second fuel pump motor 114.

In response to one of the first fuel pump motor 112 and the second fuel pump motor 114 becoming inoperable, the variable drive controllers 166 and 168 increase the supply of electric power to the other one of the first fuel pump motor 112 and the second fuel pump motor 114 in operation. For example, in response to the first fuel pump motor 112 becoming inoperable, the variable drive controllers 166 and 168 are programmed to increase supply of electric power to the second fuel pump motor 114 in operation. As another example, the variable drive controllers 166 and 168 are programmed to, in response to the second fuel pump motor 114 becoming inoperable, increase supply of electric power to the first fuel pump motor 112 in operation.

The variable drive controllers 166 and 168 are configured to increase the supply of electric power to the other operable pump motor 112, 114 up to 100 percent power of that pump motor 112, 114 so that the operable pump motor 112, 114 is supplying 100 percent of the power to operate the pump 116. The variable drive controllers 166 and 168 may detect that one of the pump motors 112, 114 is inoperable based on one or more of a voltage and/or amperage demand of the pump motors 112, 114, a rotational speed or torque reading of the pump motors 112, 114, or any other suitable measurement that indicates one or both pump motors 112, 114 have degraded or are fully inoperable.

Since both fuel pump motors 112 and 114 are normally operating and providing pumping power at the correct pump speed, if one of the motors fails there is no delay for the remaining motor to increase the power required to maintain the speed of the pump. This will minimize the fuel flow dip after loss of one of the motors and avoid gas turbine engine flameout.

Further the rate of any speed increase of the motors can be limited to avoid fuel flow increases that could stall the gas turbine compressor based on pre-programmed fuel flow rate limits. This will ensure that in any fuel transient following a pump motor failure will not surge the gas turbine.

With reference to FIG. 2B, each of the first oil pump motor 122 and the second fuel pump motor 124 is electrically connected such that the oil pump 126 is configured to be driven by both or a single one of the first oil pump motor 122 and the second oil pump motor 124. To meet a predefined oil flow demand that may correspond to a predefined speed of the oil pump 126, one or both of the third variable drive controller 170 and the fourth variable drive controller 172 supply a predefined amount of electric power to a corresponding one of the first oil pump motor 122 and the second oil pump motor 124 to drive the oil pump 126 to achieve the required pump speed.

The oil pump 126 illustratively includes a plurality of pumping elements as suggested in FIG. 2B. The oil pump 126 includes a first pumping element 154 fluidly connected to a first oil scavenge line 180 and a second pumping element 156 fluidly connected to a second oil scavenge line 182. The oil pump 126 further includes a third pumping element 158 fluidly connected to a lubrication supply line 184 of the gas turbine engine. The oil system 106 further includes a valve assembly 186 fluidly connected with the lubrication supply line 184.

The third variable drive controller 170 and the fourth variable drive controller 172 may be commanded or programmed to vary electric power supplied to the first oil pump motor 122 and to the second oil pump motor 124 based on a power demand of the oil pump 126 to maintain a predefined target pump speed. In one example, the third variable drive controller 170 and the fourth variable drive controller 172 may be programmed to control the electric power supplied to the first oil pump motor 122 and the second oil pump motor 124 and divide and optimize the power demand of the oil pump 126 between the first oil pump motor 122 and the second oil pump motor 124. The power distribution may split 100 percent power in any amount between the two pump motors 122, 124. For example, the power may be distributed 50/50, 40/60, 30/70, 25/75, 20/80, 10/90, 5/95, 0/100 between the two pump motors 122, 124. The split of power for each of the pump motors can be controlled by controlling the ratio of torques output by the pump motors, for example, equal output torque values providing a 50/50 power split.

In some instances, each of the first oil pump motor 122 and the second oil pump motor 124 is configured to operate in a speed control mode. In other instances, each of the first oil pump motor 122 and the second oil pump motor 124 is configured to operate in a torque control mode. In still another example, the controller 118 is programmed to operate one of the first oil pump motor 122 and the second oil pump motor 124 in the speed control mode and another one of the first oil pump motor 122 and the second oil pump motor 124 in the torque control mode.

In response to one of the first oil pump motor 122 and the second oil pump motor 124 becoming inoperable, the variable speed drives 170 and 172 increases supply of electric power to the other one of the first oil pump motor 122 and the second oil pump motor 124 in operation. For example, in response to the first oil pump motor 122 becoming inoperable, the variable speed drives 170 and 172 are programmed to increase supply of electric power to the second oil pump motor 124 in operation. As another example, the variable speed drives 170 and 172 are programmed to, in response to the second oil pump motor 124 becoming inoperable, increase supply of electric power to the first oil pump motor 122 in operation.

The variable speed drives 170 and 172 are configured to increase the supply of electric power to the other operable pump motor 122, 124 up to 100 percent power of that pump motor 122, 124 so that the operable pump motor 122, 124 is supplying 100 percent of the power to operate the pump 126. The variable speed drives 170 and 172 may detect that one of the pump motors 122, 124 is inoperable based on one or more of a voltage and/or amperage demand of the pump motors 122, 124, a rotational speed or torque reading of the pump motors 122, 124, or any other suitable measurement that indicates one or both pump motors 122, 124 have degraded or are fully inoperable.

FIG. 2C illustrate a pumping system 200-C for use with a gas turbine engine. The pumping system 200-C includes the fuel system 104 configured for redundant powered operation using overrunning clutches 188, 190. The first fuel pump motor 112 and the second fuel pump motor 114 of the fuel system 104 are both mechanically to the fuel pump 116 via the overrunning clutches 188 and 190.

When one of the first and second fuel pump motors 112, 114 becomes inoperable, that fuel pump motor 112, 114 may cause backdriving and/or braking effect on the fuel pump motor 112, 114 that is still operating. The overrunning clutches 188 and 190 may assist in preventing, or minimizing, any such backdriving and/or braking effect by decoupling the inoperable fuel pump motor from the fuel pump shaft 118. Put another way, the first fuel pump motor 112 and the second fuel pump motor 114 that becomes inoperable does not add drag to the first fuel pump motor 112 and the second fuel pump motor 114 still in operation.

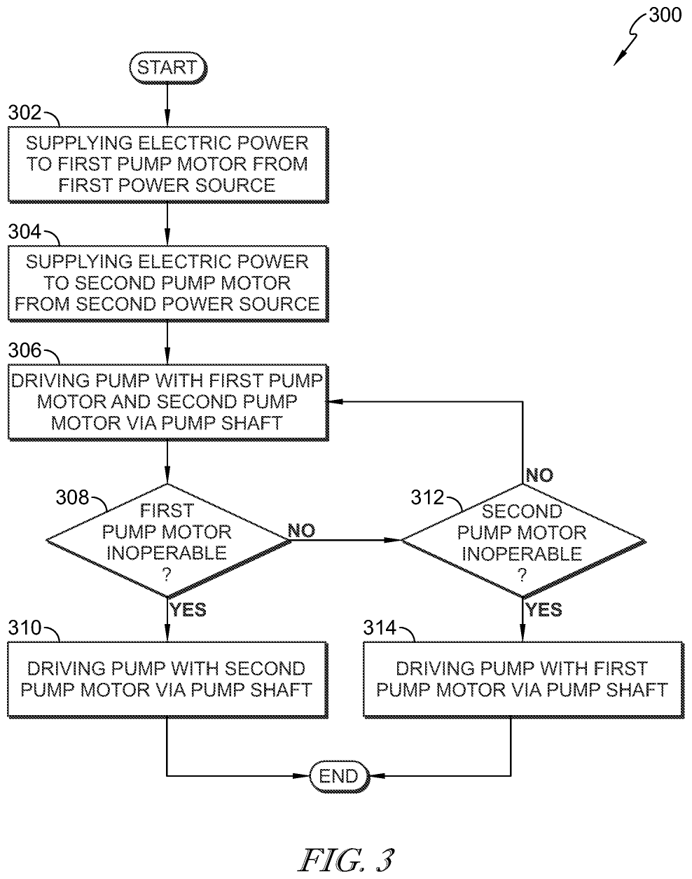

FIG. 3 illustrates an example process 300 for providing redundant power in a system with a gas turbine engine. In an example, one or more operations of the process 300 may be performed by the controller 138 that includes multiple independent and isolated variable drive controllers or by one or more other individual controllers in accordance with the present disclosure. As described in reference to at least FIGS. 1, 2A, 2B, and 2C the controller 138 communicates with one or more variable drive controllers, such as, the first variable drive controller 166, the second variable drive controller 168, the third variable drive controller 170, and the fourth variable drive controller 172, that drive the pump with one of the first pump motor and the second pump motor, in response to the other of the first pump motor and the second pump motor becoming inoperable, to continuously drive the pump without interruption.

The process 300 begins at block 302, where the controller 138, e.g., via one or more variable drive controllers, supplies electric power to the first pump motor 112, 122 from the first power supply 108 of the plurality of power supplies 108, 110, 115. The controller 138, at block 304, supplies electric power, e.g., via one or more variable drive controllers, to the second pump motor 114, 124 from the second power supply 110 of the plurality of power supplies 108, 110, 115. At block 306, the controller 138, e.g., via one or more variable drive controllers, drives the pump 116, 126 with the first pump motor 112, 122 and the second pump motor 114, 124 via a pump shaft 118, 128.

The controller 138, at block 308, determines whether the first pump motor 112, 122 is inoperable. In response to the first pump motor 112, 122 being inoperable, the controller 138 drives, e.g., via one or more variable drive controllers, the pump 116, 126 with the second pump motor 114, 124, at block 310. In response to the first pump motor 112, 122 being operable, i.e., not inoperable, the controller 138 continues to block 312, wherein the controller 138 determines whether the second pump motor 114, 124 is inoperable.

In response to the second pump motor 114, 124 being operable, i.e., not inoperable, the controller 138 returns to block 306 where the controller 138 drives, e.g., via one or more variable drive controllers, the pump 116, 126 with the first pump motor 112, 124 and the second pump motor 114, 124. In response to the second pump motor 114, 124 being inoperable, the controller 138, at block 314, drives, e.g., via one or more variable drive controllers, the pump 116, 126 with the first pump motor 112, 122. The process 300 may then end for example in response to the gas turbine engine being shut down.

An example arrangement of redundant electrical drives includes two fuel pump motors or motor power supplies on common fuel pump shaft. For example, the arrangement may include a first fuel pump motor coupled to a first power supply that is driven by a first power source, such as, but not limited to, a high power electrical starter generator. As another example, the arrangement may include a second fuel pump motor coupled to a second power supply that is driven by a second power source, such as, but not limited to, a different generator or a battery.

In one example, to avoid, or to minimize, fuel flow interruption, the first and second power supplies coupled to the first and second redundant fuel pump motors may be active. The first fuel pump motor may be configured to operate in a speed control mode and the second fuel pump motor may be configured to operate in a torque control mode. Operating the first fuel pump motor in the speed control mode and the second fuel pump motor in the torque control mode may support achieving an optimum power split between the fuel pump motors, such that a portion of power demand supplied by each of the first fuel pump motor and the second fuel pump motor may be adjusted according to respective power availability, capacity, and other parameters of the first fuel pump motor and the second fuel pump motor.

For both the fuel and oil pumps to facilitate optimum load sharing and the transfer of torque and power to one motor, both motors can be operated in speed control mode with a variable torque limit. The variable torque limits can be programmed as a function of speed and be commanded to change based on the optimum power split between the to motors. In the event one motor fails and the speed dips this could trigger an increase in the torque limit for the second motor.

Such load sharing between the two fuel pump motors being powered by different power sources may increase efficiency of the aircraft propulsion system, as a whole, and/or one or more subsystems of the of the aircraft propulsion system by optimizing which power source is used at any given instance depending on the available power from each power source and the efficiency of the power sources at that operating condition.

Load sharing can also optimize the power from each pump to minimizing the effects of, component over-temperature or health to avoid damage to any one component of the redundant system,

An example arrangement of redundant electrical drives includes two oil pump motors or motor power supplies on common oil pump shaft. For example, the arrangement may include a first oil pump motor coupled to a first power supply that is driven by a first power source, such as, but not limited to, a high power electrical starter generator. As another example, the arrangement may include a second oil pump motor coupled to a second power supply that is driven by a second power source, such as, but not limited to, an aircraft power source, a low power generator, and so on.

In one example, to avoid, or to minimize, oil flow interruption the first and second power supplies coupled to the first and second redundant oil pump motors may be active. The first oil pump motor may be configured to operate in a speed control mode and the second oil pump motor may be configured to operate in a torque control mode. Operating the first oil pump motor in the speed control mode and the second oil pump motor in the torque control mode may support achieving an optimum power split between the oil pump motors, such that a portion of power demand supplied by each of the first oil pump motor and the second oil pump motor may be adjusted according to respective power availability, capacity, and other parameters of the first oil pump motor and the second oil pump motor.

Such load sharing between the two oil pump motors being coupled to different power supplies that are, in turn, electrically connected to different power sources may increase efficiency of the aircraft propulsion system, as a whole, and/or one or more subsystems of the of the aircraft propulsion system by optimizing which aircraft power source is used at any given instance dependent on the available power for each power source or depending on the efficiency of the power sources at that condition.

Load sharing between the two oil pump motors may be used minimize the effects of, component over-temperature or component health to avoid damage of any one component of the redundant system. As just some examples, load sharing may be implemented using torque droop control, e.g., decreasing output frequency of a drive in response to output torque of that drive being greater than a predefined output torque threshold, or using speed and torque control.

An example redundant electrical drives arrangement includes a fuel system having two separately (electrically) driven pumping components. Each pumping components may be configured to provide a predefined minimum fuel flow during operation. Each one of the two pumping components may be configured to provide up to a predefined maximum fuel flow in response to the other fuel pump stopping operation, where the predefined maximum fuel flow corresponds to a maximum fuel flow demand of the system.

The redundant electrical drive arrangement of the present disclosure providing uninterrupted, or nearly uninterrupted, system operation by avoiding flameout and other conditions in response to sudden single drive failure and so on. The disclosed redundant electrical drive system is configured to prevent mechanical or electrical consumption by the failed component of the system, e.g., added drag, that may limit effectiveness of the motor still in operation.

Power or torque of each of the first pump motor and the second pump motor may be optimized to maximize efficiency without exceeding capability of each of the first pump motor and the second pump motor or the respective variable drive controllers. For example, each of the first pump motor and the second pump motor may be configured to operate such that a corresponding amount (or a portion, or a proportion) of power delivered by the first pump motor and the second pump motor is based on the temperature or health of the motors and the respective variable drive controllers. During a starting operation, one or both of the first pump motor and the second pump motor may generate a portion or all power used to initiate operation of the gas turbine.

The redundant electrical drive system of the present disclosure supports controlling the power demand for each of the power sources of the first oil pump motor and the second oil pump motor by controlling torque of the respective one of the first oil pump motor and the second oil pump motor. For example, power necessary to operate the oil pump is a product of an angular velocity of the shaft and a combination of a first torque of the first oil pump motor and a second torque of the second oil pump motor. In other words, values of the first torque and the second torque may be adjusted relative to one another to a total torque value necessary to operate the oil pump.

In some instances, amount of power used to overcome drag generated by a pump motor that has become inoperable may constitute a large portion of pumping power used to maintain seemless system operation. Likewise, a size of the corresponding power source to each of the first and second pump motors may need to be able to accommodate additional power used to overcome the power drag when the pump motor supported by the other power source becomes inoperable. Thus, frequently, one or both pump motors, as well as, power sources providing energy to these pump motors in a redundant system may need to be configured to support such an additional power usage, thereby adding significant weight, cost and volume to embedded generator. Also, if bearings fail in one motor or motor seizes due to an over-temperature condition, then failed motor torque could prevent pumping by remaining motor.

In the redundant system of the present disclosure, the first and second fuel pump motors driving a fuel pump are connected in series via the pump shaft. A first overrunning clutch is coupled with the first fuel pump motor and a second overrunning clutch is coupled with the second fuel pump motor. The first overrunning clutch is configured to decouple the first fuel pump motor from the shaft in response to the first fuel pump motor becoming inoperable. The second overrunning clutch is configured to decouple the second fuel pump motor from the shaft in response to the second fuel pump motor becoming inoperable. Implementing an overrunning clutch coupling prevents, or minimizes effects of, a back-drive and/or braking effect of the first fuel pump motor when the first fuel pump motor becomes inoperable and a back-drive and/or braking effect of the second fuel pump motor when the second fuel pump motor becomes inoperable. Put another way, the first fuel pump motor and the second fuel pump motor that becomes inoperable does not add drag to the first fuel pump motor and the second fuel pump motor still in operation, which, in turn, enables implementation of fuel pump motors having smaller size and/or smaller input power capabilities than may be necessary to support redundant fuel pump motors not coupled using the overrunning clutch.

In the redundant system of the present disclosure, the first and second oil pump motors driving an oil pump may be connected with one another through an overrunning clutch. Implementing the overrunning clutch coupling may assist in preventing, or minimizing effects of, a back-drive and/or braking effect of the first oil pump motor and the second oil pump motor when the first oil pump motor and the oil second pump motor, respectively, become inoperable. Put another way, the first oil pump motor and the second oil pump motor that becomes inoperable does not add drag to the first oil pump motor and the second oil pump motor still in operation, which, in turn, enables implementation of oil pump motors having smaller size and/or smaller input power capabilities than may otherwise be necessary to support redundant oil pump motors not coupled using the overrunning clutch.

One embodiment of the pumping system of the present invention includes using induction motors as the oil pump motors where the exact volumetric oil flow is not critical to the operation of the engine. Induction motors have the advantage of inherent load sharing.

An example implementation of the pumping system of the present disclosures includes a motor generator having a plurality of power supplies and a fuel system configured for redundant powered operation. The fuel system includes a first fuel pump motor, a second fuel pump motor, a fuel pump, and a fuel pump shaft. The first fuel pump motor and the second fuel pump motor are mechanically connected in series with the fuel pump via the fuel pump shaft, and each of the first fuel pump motor and the second fuel pump motor being electrically connected to the plurality of power supplies such that the fuel pump is configured to be driven by both or a single one of the first fuel pump motor and the second fuel pump motor. The pumping system includes an oil system configured for redundant powered operation. The oil system including a first oil pump motor, a second oil pump motor, an oil pump, and an oil pump shaft. The first oil pump motor and the second oil pump motor are mechanically connected in series with the oil pump via the oil pump shaft, and each of the first oil pump motor and the second oil pump motor being electrically connected to the plurality of power supplies such that the oil pump is configured to be driven by both or a single one of the first oil pump motor and the second oil pump motor.

One other embodiment of the pumping system of the present disclosure includes a controller programmed to control at least one of speed and torque of the first fuel pump motor and second fuel pump motor to drive the fuel pump at a predefined speed, wherein the predefined speed of the fuel pump is based on fuel flow requested by the engine.

Another embodiment of the pumping system of the present disclosure includes a controller programmed to control electric power supplied to the first fuel pump motor and the second fuel pump motor to optimize the power demand from the engine or aircraft power sources and provide a total power and torque output to cause the fuel pump to operate at the predefined speed.

Still another embodiment of the pumping system of the present disclosure includes the controller being programmed to increase electric power to the first fuel pump motor in response to the second fuel pump motor becoming inoperable.

Yet another embodiment of the pumping system of the present disclosure includes the controller being programmed to drive one of the first fuel pump motor and the second fuel pump motor based on a torque limit.

Another embodiment of the pumping system of the present disclosure includes a power split for each of the first fuel pump motor and the second fuel pump motor being optimized based on a maximum operating temperature of the first fuel pump motor, second fuel pump motor and the dedicated controllers.

Still another embodiment of the pumping system of the present disclosure includes a controller programmed to control speed or torque of the first oil pump motor and the second oil pump motor based on the oil flow requested by the engine.

Another embodiment of the pumping system of the present disclosure includes the controller being programmed to control the power or torque supplied to the first oil pump motor and the second oil pump motor according to the power demand from the engine and aircraft power sources.

Yet another embodiment of the pumping system of the present disclosure includes the controller being configured to increase electric power to the first oil pump motor in response to the second oil pump motor becoming inoperable.

Still another embodiment of the pumping system of the present disclosure includes the controller being programmed to drive one of the first oil pump motor and the second oil pump motor based on a torque limit.

As another example, the pumping system of the present disclosure includes an overrunning clutch coupled with the first pump motor and the second pump motor. The overrunning clutch is configured to permit the first pump motor to drive the pump without driving the second pump motor, in response to the second pump motor becoming inoperable.

In an example, a pumping system of the present disclosure includes a motor generator having a plurality of power supplies, a first pump motor, a second pump motor, a pump, and a pump shaft. The first pump motor is electrically connected to the plurality of power supplies, the second pump motor is electrically connected to the plurality of power supplies, and the first pump motor and the second pump motor being coupled to the pump via the pump shaft to provide single or redundant supply of power to operate the pump.

As yet another example, the pumping system of the present disclosure provides redundant supply of power by providing uninterrupted operation of the pump in response to one of the first pump motor and the second pump motor stopping operation.

Another embodiment of the pumping system of the present disclosure is such that one of the first pump motor and the second pump motor operates in a speed control mode.

Still another embodiment of the pumping system of the present disclosure is such that one of the first pump motor and the second pump motor operates in a torque control mode.

One embodiment of the pumping system of the present disclosure is such that the first pump motor is a first fuel pump motor, the second pump motor is a second fuel pump motor, the pump is a fuel pump, and the pump shaft is a fuel pump shaft.

Another embodiment of the pumping system of the present disclosure is such that the first pump motor is a first oil pump motor, the second pump motor is a second oil pump motor, the pump is an oil pump, and the pump shaft is an oil pump shaft.

Still another embodiment of the pumping system of the present disclosure is such that each of the first pump motor and the second pump motor is electrically powered by a different one of the plurality of power supplies.

Yet another embodiment of the pumping system of the present disclosure is such that the plurality of power supplies include one of an engine generator winding and an aircraft power bus.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A pumping system for use with a gas turbine engine, the pumping system comprising:
a fuel system configured for redundant operation, the fuel system including a first fuel pump motor, a second fuel pump motor, a fuel pump, and a fuel pump shaft, wherein the first fuel pump motor and the second fuel pump motor are mechanically connected in series with the fuel pump via the fuel pump shaft, such that the fuel pump is configured to be driven by both or a single one of the first fuel pump motor and the second fuel pump motor wherein the fuel system further comprises a first controller programmed to control at least one of speed and torque of the first fuel pump motor and a second controller programmed to control at least one of speed and torque of the second fuel pump motor to drive the fuel pump at a predefined speed, wherein the predefined speed of the fuel pump is based on fuel flow requested by the gas turbine engine; and
an oil system configured for redundant operation, the oil system including a first oil pump motor, a second oil pump motor, an oil pump, and an oil pump shaft, wherein the first oil pump motor and the second oil pump motor are mechanically connected in series with the oil pump via the oil pump shaft, such that the oil pump is configured to be driven by both or a single one of the first oil pump motor and the second oil pump motor, wherein the oil system further comprises a third controller programmed to control at least one of speed and torque of the first oil pump motor and a fourth controller programmed to control at least one of speed and torque of the second oil pump motor based on oil flow requested by the gas turbine engine.

2. (canceled)

3. The pumping system of claim 1, further comprising a plurality of independent power sources, wherein the first fuel pump motor is electrically powered by one of the plurality of independent power sources and the second fuel pump motor is electrically powered by a different one of the plurality of independent power sources, wherein the first controller and the second controller are programmed to control electric power supplies to the first fuel pump motor and the second fuel pump motor to optimize the power demand from the one and the different one of the plurality of independent power sources and provide a total power and torque output to cause the fuel pump to operate at the predefined speed.

4. The pumping system of claim 1, wherein the first controller is programmed to increase electric power to the first fuel pump motor in response to the second fuel pump motor becoming inoperable.

5. The pumping system of claim 1, wherein the first controller and the second controller are programmed to drive one of the first fuel pump motor and the second fuel pump motor based on a torque limit.

6. The pumping system of claim 1, where a power split for each of the first fuel pump motor and the second fuel pump motor is optimized based on a maximum operating temperature of the first fuel pump motor, the second fuel pump motor, the first controller, and the second controller.

7. (canceled)

8. The pumping system of claim 1, wherein the third controller and the fourth controller are programmed to control the power or torque supplied to the first oil pump motor and the second oil pump motor to optimize the power demand from the gas turbine engine and aircraft power sources.

9. The pumping system of claim 1, wherein the third controller is programmed to increase electric power to the first oil pump motor in response to the second oil pump motor becoming inoperable.

10. The pumping system of claim 1, wherein the third controller and the fourth controller are programmed to drive one of the first oil pump motor and the second oil pump motor based on a torque limit.

11. (canceled)

12. A pumping system for use with a gas turbine engine, the pumping system comprising:
a plurality of independent power supplies;
a first pump motor, a second pump motor, a pump, a first controller, a second controller, and a pump shaft, the first pump motor being electrically powered by one of the plurality of independent power supplies, the second pump motor being electrically powered by a different one of the plurality of independent power supplies, and the first pump motor and the second pump motor being coupled to the pump via the pump shaft to provide single or redundant supply of power to operate the pump, the first controller programmed to control at least one of speed and torque of the first pump motor and the second controller programmed to control at least one of speed and torque of the second pump motor, wherein the first controller is configured to detect the speed and torque of the first pump motor and the second controller is configured to detect the speed and torque of the second pump motor.

13. The pumping system of claim 12, wherein to provide redundant supply of power includes to provide uninterrupted operation of the pump in response to one of the first pump motor and the second pump motor stopping operation.

14. The pumping system of claim 12, wherein one of the first pump motor and the second pump motor operates in a speed control mode.

15. The pumping system of claim 14, wherein another one of the first pump motor and the second pump motor operates in a torque control mode.

16. The pumping system of claim 12, wherein the first pump motor is a first fuel pump motor, the second pump motor is a second fuel pump motor, the pump is a fuel pump, and the pump shaft is a fuel pump shaft.

17. The pumping system of claim 12, wherein the first pump motor is a first oil pump motor, the second pump motor is a second oil pump motor, the pump is an oil pump, and the pump shaft is an oil pump shaft.

18. The pumping system of claim 12, wherein the pumping system includes a first overrunning clutch coupled with the first pump motor and a second overrunning clutch coupled with the second pump motor, wherein the overrunning clutch is configured to permit the first pump motor to drive the pump without driving the second pump motor, in response to the second pump motor becoming inoperable.

19. The pumping system of claim 12, wherein the plurality of power supplies includes one of an engine generator winding or an aircraft power bus.

20. (canceled)

21. The pumping system of claim 1, wherein the first controller is configured to detect an amperage demand of the first fuel pump motor and determine failure of the first fuel pump motor based on the amperage demand of the first fuel pump motor and the second controller is configured to detect an amperage demand of the second fuel pump motor and determine failure of the second fuel pump motor based on the amperage demand of the second fuel pump motor.

22. The pumping system of claim 1, wherein the third controller is configured to detect an amperage demand of the first oil pump motor and determine failure of the first oil pump motor based on the amperage demand of the first oil pump motor and the fourth controller is configured to detect an amperage demand of the second oil pump motor and determine failure of the second oil pump motor based on the amperage demand of the second oil pump motor.

23. A pumping system for use with a gas turbine engine, the pumping system comprising:
a fuel system configured for redundant operation, the fuel system including a first fuel pump motor, a second fuel pump motor, a fuel pump, a first controller, a second controller, a fuel pump shaft, a first overrunning clutch, and a second overrunning clutch, the first controller programmed to control at least one of speed and torque of the first fuel pump motor, the second controller programmed to control at least one of speed and torque of the second fuel pump motor, the first overrunning clutch coupled with the first fuel pump motor and the second overrunning clutch coupled with the second fuel pump motor, wherein the first overrunning clutch is configured to permit the first fuel pump motor to drive the fuel pump without driving the second fuel pump motor in response to the second fuel pump motor becoming inoperable, the second overrunning clutch is configured to permit the second fuel pump motor to drive the fuel pump without driving the first fuel pump motor in response to the first fuel pump motor becoming inoperable, and
an oil system configured for redundant operation, the oil system including a first oil pump motor, a second oil pump motor, an oil pump configured to be mechanically driven by one or both of the first oil pump motor and the second oil pump motor, a third controller, and a fourth controller, the third controller programmed to control at least one of speed and torque of the first oil pump motor and the fourth controller programmed to control at least one of speed and torque of the second oil pump motor.
